(19) United States
(12) Patent Application Publication
(10) Pub. No.: US 2025/0039957 A1
(43) Pub. Date: Jan. 30, 2025

(54) STATUS REPORT FRAME FOR EASIER REATTACHMENT

(71) Applicant: Cisco Technology, Inc., San Jose, CA (US)

(72) Inventors: Jerome Henry, Pittsboro, NC (US); Javier Contreras, Barcelona (ES)

(73) Assignee: Cisco Technology, Inc., San Jose, CA (US)

(21) Appl. No.: 18/772,942

(22) Filed: Jul. 15, 2024

Related U.S. Application Data
(60) Provisional application No. 63/513,545, filed on Jul. 13, 2023.

(51) Int. Cl. H04W 76/10; H04W 12/08; H04W 48/08; H04W 84/12

(52) U.S. Cl. CPC H04W 76/10; H04W 12/08; H04W 48/08; H04W 84/12

(57) ABSTRACT

A status report frame may be provided. First, an Access Point (AP) may associate with a client device. Then the AP may send a status report to the client device in a status report frame comprising a protected management frame.

### RELATED APPLICATION TECHNICAL FIELD

Under provisions of 35 U.S.C. § 119(e), Applicant claims the benefit of U.S. Provisional Application No. 63/513,545 filed Jul. 13, 2023, which is incorporated herein by reference.

### TECHNICAL FIELD

The present disclosure relates generally to providing a status report frame for easier reattachment.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing a status report frame;

FIG. 2 is a flow chart of a method for providing a status report frame; and

FIG. 3 is a block diagram of a computing device.

### DETAILED DESCRIPTION

### Overview

A status report frame may be provided. First, an Access Point (AP) may associate with a client device. Then the AP may send a status report to the client device in a status report frame comprising a protected management frame.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

For Institute of Electrical and Electronics Engineers (IEEE) 802.11 wireless networks, there may be a concern for privacy and security of the user identity and the traffic transmitted over the air. Over the years, different device implementations have developed processes to hide the Media Access Control (MAC) addresses used over the air, moving away from manufacturer assigned Organizationally Unique Identifier (OUI), to locally administered addresses, in an effort to reduce device tracking. These locally administered addresses may be randomly allocated from a 46 bit address space, indicating they are local by setting the second least significant bit of the first octet of the address (i.e., Universal/Local bit). This randomized address may be changed following different policies and times, depending on the device implementation for example.

IEEE 802.11bh may provide device identification of wireless stations that may be using a randomized MAC address, but may still allow protection from third parties. In IEEE 802.11bh, there may be two concepts introduced: i) Identifiable Random MAC (IRM)—this may be a future MAC address selected by a non-AP Station (STA), sent to the AP during device network onboarding process; and ii) Device-ID—this may be an element sent from the AP to the non-AP STA that may allow for identifying the non-AP STA as it traverses an Extended Service Set (ESS).

There may be different scenarios where the handling of IRM or Device-ID may lead to different problems arising from their nature. First, a non-AP STA (e.g., a client device) may select an IRM matching the same value as another non-AP STA present in the ESS. This may be a low probability scenario, but still possible (e.g., in cases where both STAs may be from the same vendor and use a simplistic algorithm to pick up the IRM), or it may be an intentional malicious activity performed by an internal or external attacker. Second, the IRM selected by the AP-STA may not be recognized as a possible identity of the AP. Third, the AP may provide a Device-ID to the non-AP STA, and in turn, the non-AP STA may not provide it back to the AP as defined in IEEE 802.11bh during the different protocol onboarding scenarios. And fourth, a Device-ID returned by the non-AP STA may not be recognized by the network.

There may be other possible issues that may be signaled to a non-AP STA, either to allow handling on the device itself, or to perform notifications to a user that the network may take administrative actions derived from not recognizing their device identity. This may be different from a failure to authenticate to the network, using whatever mechanism has been defined for the ESS. Accordingly, embodiments of the disclosure may provide processes for an AP to signal to a non-AP STA (e.g., a client device) the non-AP STA's status over a protected management frame. The status may indicate the success or failure of elements communicated by the non-AP STA to the AP.

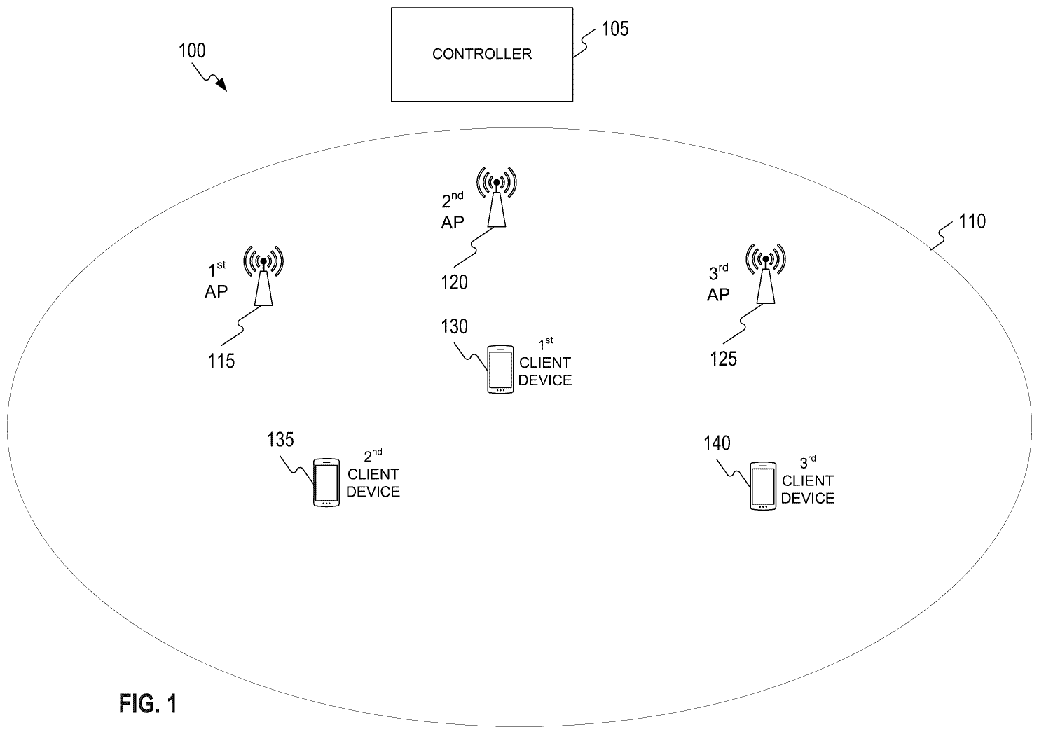

FIG. 1 shows an operating environment 100 for providing a status report frame. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11ax specification standard for example.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide a status report frame.

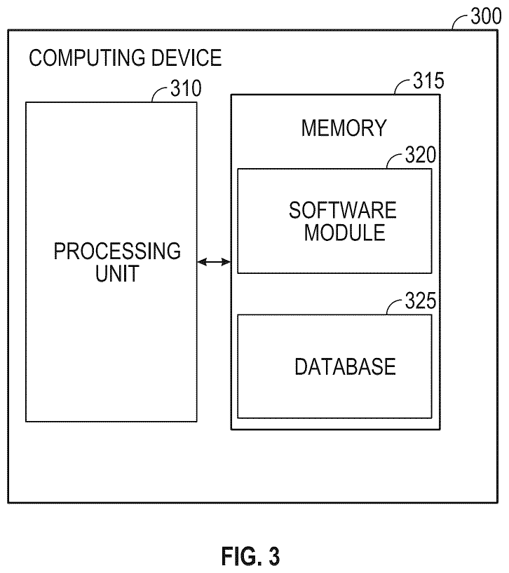

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

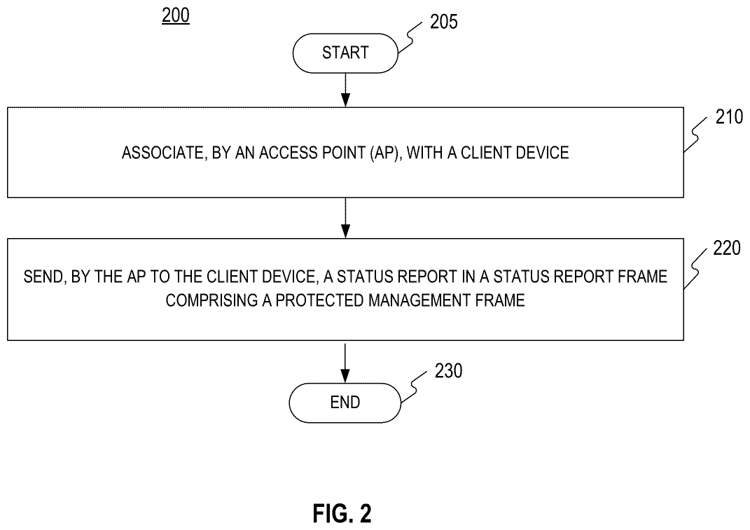

FIG. 2 is a flow chart setting forth the general stages involved in a method 200 consistent with embodiments of the disclosure for providing a status report frame. Method 200 may be implemented using computing device 300 as described in more detail below with respect to FIG. 3. Computing device 300 may be embodied by first AP 115. Ways to implement the stages of method 200 will be described in greater detail below.

Embodiments of the disclosure may provide a secure and granular process for an AP to provide notifications to a non-AP STA that there may be a policy error or STA status (e.g., as set by the infrastructure) information that the STA needs to know. This may ensure that the information may be granular enough to ensure different status or error scenarios may be shared with the non-AP STA. In addition, this may ensure that the notification may be secure from eavesdroppers (e.g., protected). Furthermore, this may ensure that the notification may not be used to determine which identities (e.g., IRM or Device-ID) may be valid on a given network. Moreover, this may ensure that a notification frame may not have any particular size or characteristics that could be used to perform traffic analysis by a third party to determine if the identifiers used are valid or not in the network.

Method 200 may begin at starting block 205 and proceed to stage 210 where first AP 115 may associate with first client device 130. For example, first client device 130 (e.g., a non-AP STA) may complete a selected authentication process with first AP 115. This may be required by the ESS/Network configuration. This association may be either a full association or establishment of a Pre-Association Security Negotiation (PASN) secure connection for example.

From stage 210, where first AP 115 associates with first client device 130, method 200 may advance to stage 220 where first AP 115 may send, to first client device 130, a status report in a status report frame comprising a protected management frame. For example, first AP 115 may notify first client device 130 of first client device 130's status in the cell, through the use of a robust action frame (i.e., the status report frame). In one embodiment, the status report frame may be sent unsolicited to first client device 130. This embodiment may be useful in scenarios where first client device 130 may express elements that it expects first AP 115 to measure (e.g., first client device 130 sends a Device ID or uses an IRM). The status report frame may express that the status is successful or not, for one or more elements communicated by first client device 130, or one or more elements of a policy defined on first AP 115 or the infrastructure.

In another embodiment, the status report frame may be sent through an exchange. In this example embodiment, first client device 130 may decide (e.g., automatically following association, or upon some trigger, for example, inability to communicate with a particular service that first client device 130's Operating System (OS) expected to be reachable) to send a status report query frame to first AP 115. This query may be directed (e.g., what is my IRM status) or undirected (e.g., tell me the statuses you know for me). First AP 115 may reply with the status report frame accordingly.

The status report frame may include information about what policies or actions may be applied by the network, as result of the validation of the identities provided (e.g., IRM, Device ID, station type, or other parameters relevant for the infrastructure policy). There may be multiple policies returned as results of such evaluation. The status report frame may comprise, but is not limited to, the following two formats: i) Fixed Length format; and ii) Type Length Value (TLV) format.

### Fixed Length

In fixed length embodiment, the frame type may include an element ID/type/length and a status report segment that may include zero or more status reports. A status report count field may indicate the number of reports provided, and for each report, a status type field that may indicate which status is reported, and a status report field that may indicate a numeral representing that status for the particular type. The frame may be extensible (as multiple reports may be sent), but its size may be limited, as each report type and report value may comprise numerals with a field of fixed size. Accordingly, this embodiment may allow for a relatively short frame size.

To provide resistance against traffic analysis attacks, a padding subtype may be defined that may be used to add extra bytes to randomly alter the overall frame size. First client device 130 may ignore these sub elements. The payload of the status report frame having the fixed length format may be defined as illustrated by Table 1. Table 2 illustrates example status types.

TABLE 1

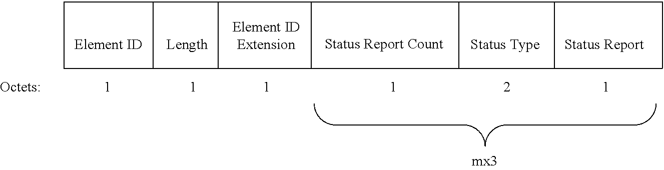

TABLE 2

| Status | Status | Status | |
|---|---|---|---|
| Type | Type | Field | |
| Value | Name | Value | Status Field Name |
| 0 | Padding | 0 | Extra bytes that can be |
| | | | added as padding |
| | | 1-255 | Reserved |
| 1 | IRM | 0 | Recognized |
| | | 1 | IRM not recognized |
| | | 2 | IRM Duplicated |
| | | 3 | IRM Missing |
| | | 4-255 | Reserved |
| 2 | Device-ID | 0 | Device-ID recognized |
| | | 1 | Device-ID not recognized |
| | | 2 | Device-ID duplicated |
| | | 3 | Device-ID missing |
| | | 3-255 | Reserved |
| 3 | Identity-Policy- | 0 | Successful/No actions |
| | Notification | 1 | STA is quarantined |
| | | | (restricted access) |
| | | 2 | STA will not get network access |
| | | 3 | STA will be subject to QoS |
| | | | restrictions |
| | | 4-255 | Reserved |
| 4-255 | Reserved | | |

### Type Length Value (TLV)

In another embodiment, the frame structure may include sub elements. This structure may allow for additional flexibility and more complex notifications to be sent to first client device 130, including arbitrary strings as defined by network administration. This embodiment may be useful as it may allow the infrastructure to communicate messages of variable length to first client device 130, including messages that may be human-readable and then displayed to first client device 130's user on first client device 130. Compared to the aforementioned fixed length format, the TLV format may comprise a longer frame structure, as each notification may comprise a sub element (e.g., with an overhead of sub element ID and length, in addition to the status type and status report). The payload of the status report frame having the TLV format may be defined as illustrated by Table 3. Table 4 illustrates example status sub elements.

TABLE 3

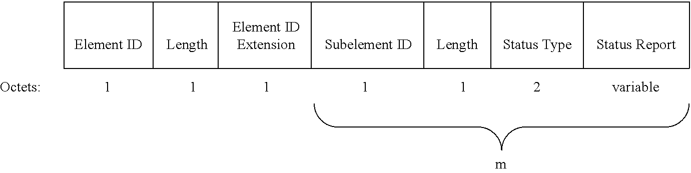

TABLE 4

| Status | Status | | Status | |
|---|---|---|---|---|
| Type | Type | Status | Field | |
| Value | Length | Type Name | Value | Status Field Name |
| 0 | Variable | Padding | 0 | Extra bytes that can be |
| | | | | added as padding |
| | | | 1-255 | Reserved |
| 1 | 1 | IRM | 0 | Recognized |
| | | | 1 | IRM not recognized |
| | | | 2 | IRM Duplicated |
| | | | 4 | IRM Missing |
| | | | 4-255 | Reserved |
| 2 | 1 | Device-ID | 0 | Device-ID recognized |
| | | | 1 | Device-ID not recognized |
| | | | 2 | Device-ID duplicated |
| | | | 3 | Device-ID missing |
| | | | 3-255 | Reserved |
| 3 | 1 | Identity- | 0 | Successful/No actions |
| | | Policy- | 1 | STA is quarantined |
| | | Notification | | (restricted access) |
| | | | 2 | STA will not get network |
| | | | | access |
| | | | 3 | STA will be subject to QoS |
| | | | | restrictions |
| | | | 4-255 | Reserved |
| 4 | Variable | Identity- | String | Arbitrary string with |
| | | Policy- | | additional information |
| | | Information | | about the identity policy |
| | | | | evaluation |
| 4-255 | | Reserved | | |

Once first AP 115 sends, to first client device 130, the status report in the status report frame comprising the protected management frame in stage 220, method 200 may then end at stage 230.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing a status report frame as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
associating, by an Access Point (AP) with a client device; and
sending, by the AP to the client device, a status report in a status report frame comprising a protected management frame.

2. The method of claim 1, wherein the status report comprises information about policies applied by a network.

3. The method of claim 1, wherein the status report frame comprises a fixed length format.

4. The method of claim 1, wherein the status report frame comprises a Type Length Value (TLV) records format.

5. The method of claim 1, wherein sending the status report comprises receiving the status report unsolicited by the client device.

6. The method of claim 1, wherein sending the status report comprises sending the status report in response to an exchange between the client device and the AP.

7. The method of claim 1, wherein associating with the client device comprises establishing a Pre-Association Security Negotiation (PASN) secure connection.

8. The method of claim 1, wherein associating with the client device comprises establishing a full association.

9. A system comprising:
a memory storage; and
a processing unit disposed in an Access Point (AP) and coupled to the memory storage, wherein the processing unit is operative to:
associate, by the AP, with a client device; and
send, by the AP to the client device, a status report in a status report frame comprising a protected management frame.

10. The system of claim 9, wherein the status report comprises information about policies applied by a network.

11. The system of claim 9, wherein the status report frame comprises a fixed length format.

12. The system of claim 9, wherein the status report frame comprises a Type Length Value (TLV) records format.

13. The system of claim 9, wherein the processing unit being operative to send the status report comprises the processing unit being operative to send the status report unsolicited by the client device.

14. The system of claim 9, wherein the processing unit being operative to send the status report comprises the processing unit being operative to send the status report in response to an exchange between the client device and the AP.

15. A non-transitory computer-readable medium that stores a set of instructions which when executed perform a method executed by the set of instructions comprising:
associating, by an Access Point (AP) with a client device; and
sending, by the AP to the client device, a status report in a status report frame comprising a protected management frame.

16. The non-transitory computer-readable medium of claim 15, wherein the status report comprises information about policies applied by a network.

17. The non-transitory computer-readable medium of claim 15, wherein the status report frame comprises a fixed length format.

18. The non-transitory computer-readable medium of claim 15, wherein the status report frame comprises a Type Length Value (TLV) records format.

19. The non-transitory computer-readable medium of claim 15, wherein sending the status report comprises sending the status report unsolicited by the client device.

20. The non-transitory computer-readable medium of claim 15, wherein sending the status report comprises sending the status report in response to an exchange between the client device and the AP.
